(19) United States
(12) Patent Application Publication
(10) Pub. No.: US 2008/0247288 A1
(43) Pub. Date: Oct. 9, 2008

(54) Optical Disk Drive and Tracking Error Detection Method For an Optical Disk Drive

(75) Inventor: Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,497

(22) PCT Filed: Sep. 13, 2006
(86) PCT No.: PCT/IB06/53248

§ 371 Date: Mar. 28, 2008

(30) Foreign Application Priority Data
Sep. 30, 2005 (EP) 05109086.8

(51) Int. Cl. G11B 5/58

(52) U.S. Cl. 369/53.17

(57) ABSTRACT

The present invention relates to a tracking error detection method for an optical storage system wherein an optical disk comprises a plurality of adjacent track portions with a radial track pattern in which a number n>2 of adjacent track portions repeatedly exhibit non-uniform radial track distances (TP₁≠TP₂ . . . ≠TPₙ), whereby the sum of said radial track distances (TP_{Σ}=TP₁+ . . . +TPₙ) is higher than the reciprocal optical cutoff λ/(2NA) of the optical disk drive. The method comprises projecting a plurality of (n) satellite light spots (S₁, . . . , Sₙ; S_{L}, S_{M}) and one main spot (S_{R}) onto said optical disk, each satellite spot being displaced in radial direction off the main spot by another one of half the radial track distances (TP₁/2≠TP₁/2≠ . . . ≠TPₙ/2), respectively, and generating push-pull signals (PP₁, . . . ,PPₙ; PP_{L}, _{PPM)} for each satellite spot. The invention further relates to an optical disk drive implementing said method.

The present invention relates to an optical disk drive comprising a beam generator arranged to project a plurality of satellite light spots and one main spot onto an optical disk, and a tracking error detection device comprising a photo detector array arranged to detect a reflected light from the optical disk and at least one push-pull signal generator coupled to the detector array and arranged to generate push-pull signals.

The invention further relates to a tracking error detection method for an optical storage system comprising such an optical disk drive and an optical disk.

In optical disk systems comprising an optical storage disk and an optical disk drive both radial and tangential densities of information stored on the disk are determined by the effective diameter of an optical spot Φ=λ/(2 NA) generated by a pick-up unit (PUU) of the disk drive (reciprocally corresponding to the highest spatial frequency or so-called optical cutoff 2 NA/λ), where λ and NA represent the wavelength of the laser and the numerical aperture of the objective lens, respectively. For example, in Blu-ray disk (BD) systems, with λ=405 nm and NA=0.85, the spot size will be Φ=238 nm, resulting in the minimum track pitch (distance of the center lines between adjacent track portions, determining the radial density) TP*=238 nm and minimum channel bit length T_{ch}*=59.6 nm. Note, that the channel bit length T_{ch}*=59.6 nm corresponds to the optical cutoff, determining the tangential density, with d=1 binary run-length limited (RLL) channel code. That is to say, for any track pitch smaller than TP* conventional push-pull tracking error signals (PP TES) will disappear, and for any bit length smaller than T_{ch}* data information will fall out of the optical cutoff so that threshold detection definitely does not work any more. Note, that for read-only disks, tracking is achieved by means of a so-called DTD (differential time detection) signal. The DTD signal looks at the combination of radial and tangential diffractions, so it also vanishes in the case of TP>TP*.

In the past years, higher storage densities have been achieved by further narrowing the channel bit length below T_{ch}*, thanks to advanced signal processing techniques in which PRML (partial response maximum likelihood) detection plays a key role in tackling severe inter-symbol interference (ISI), see also A. V. Padiy et al, Signal processing for 35 GB on a single-layer Blu-ray disk, ODS2004, Monterey, Calif., 2004; and J. Lee et al, Advanced PRML data detector for high density recording, ODS2004, Monterey, Calif., 2004. However, it has been recently verified by a number of companies that decreasing the channel bit length below 50 nm is getting extremely difficult if not impossible when using the BD optics in combination with the d=1 RLL channel code.

The other possibility to push the density lies in the radial direction, i.e., reducing track pitch. Thereby, care must be taken to maintain a robust tracking ability when the track pitch approaches or even exceeds the optical limit.

For (re-)writable disks, basically, there are two ways to effectively reduce the track pitch. The first is, to employ the land-groove format as known from DVD-RAM and (re-)writable HD DVD. By recording data both on lands and in grooves, the effective track pitch (land-to-groove distance) decreases by the factor of 2. The real track pitch (groove-to-groove distance) remains unchanged, which ensures robust tracking based on the conventional PP TES. Taking BD parameters as an example, if the real track pitch is the standard 320 nm, the effective track pitch is only 160 nm (compared to TP*=238 nm). Robust tracking, therefore, is not an issue in this case.

However, inter-track interference during reading (cross-talk), especially in the presence of aberrations like radial tilt and defocus, and, in case of (re-)writable disks, cross-erase during writing (cross-write) becomes an issue. If tracks get closer, cross-talk and cross-erase will become more pronounced. Cross-talk can be coped with electronically, for example, by the use of a 3-spot cross talk canceller that is able to remove the cross talk completely or partly depending on the track pitch, see for example U.S. Pat. No. 6,163,518. In that sense cross-talk seems less problematic compared to cross-erase because, roughly speaking, the latter destroys the data physically and makes it impossible to recover during reading. A very accurate laser power control therefore is required in order to achieve proper cross-erase performance, which restricts the use of this type of systems.

Therefore, for reducing the cross-erase effect, particularly in consumer products, the groove-only format (like in CD-R/RW, DVD±R/RW or BD-R/RE) is preferred with respect to the land-groove format, since the adjacent tracks are better separated thermally in the groove-only case. Note, that the cross-talk is about equally severe for both land-groove and the groove-only formats. Furthermore, for read-only disks, there is presently no possibility to increase the effective track by employing the land-groove format due to difficulties in mastering.

In order to alleviate as much as possible the efforts for improving the cross-erase performance, one will naturally think of narrowing the track pitch but still keeping the groove-only format, which is actually the second way to effectively reduce the track pitch. Then the question is whether it is possible to retain reliable tracking error signals when the track pitch approaches the optical limit.

Known radial tracking error detection methods include push-pull radial tracking, in which a signal difference between two pupil halves are measured on separate detector elements; three spot central aperture radial tracking, in which the radiation beam is split into three beams by a diffraction grating, projecting one center main spot and two outer satellite spots which are set a quarter track pitch off the main spot, whereby the difference of their signals are used to generate the tracking error signal; three spot push-pull radial tracking, in which the radiation beam is also split into three beams by a diffraction grating, but now using a difference between the differential push-pull signals of the main spot and the satellite spots as the tracking error signal. Further differential phase or time detection (DPD or DTD) radial tracking methods are known for example from EP 1 453 039, in which the contribution of the radial offset of the phase is exploited in a square-shaped quadrant spot detector. However, all known radial tracking error methods are limited to the optical cutoff 2 NA/λ determined by the laser beam.

From European Patent Application 05100149.3 (Jan. 12, 2005; PHNL050027) and European Patent Application 05104676.1 (May 31, 2005; PH000481) a concept is known, wherein a broad spiral format indirectly realizes tracking on track pitches below λ/(2 NA). The broad spiral consists of a number of tracks placed to each other at a spatial frequency higher than the optical cutoff. A guard-band separates two neighboring spirals. Its width is chosen to be comparable to the standard track pitch (around 300 nm for BD optics).

The concept was first adopted in the so-called TwoDOS system (for read-only systems), where inter-track channel bits within one spiral are hexagonally aligned so that the bit information is jointly detected with multi-track readout. The disk capacity as well as the data rate increases significantly. Two spots are positioned on the edges of two most outer tracks, which are half on the track and half on the guard-band. Tracking is realized by looking at the light intensity difference between the projections of these two spots on detectors. Tracking is solved in a joint manner, but the system is very expensive due to heavy computational load of the joint bit detection and the need of multi-cavity lasers for (re-)writable format disks.

The concept later was modified European Patent Application 05100149.5 (Jan. 12, 2005; PHNL050027), such that a single spot scans track by track within one spiral and thus normal one-dimensional detection is possible. The complexity for detection decreases, but a kind of switching mechanism for getting appropriate tracking signals from multiple detectors takes place because tracking is needed for every track, which requires the same number of spots and detectors as that of the tracks, as show in European Patent Application 05104676.1 (May 31, 2005; PH000481). This complication is also known from European Patent Application 05100149.3 (Jan. 12, 2005; PHNL050027, where a continuous spiral with small track pitches is broken regularly in order to virtually form a broad spiral enabling tracking.

Furthermore with the concept of the broad spiral, new methods or structures for embedding timing and address information onto (re)writable format disks need to be invented because any signals from the push-pull channel carried by a wobble structure embedded in the grooves of the disk become unreliable or even vanish as the track pitch within broad spirals approaches the optical cutoff or even falls below it. The wobble concept is not applicable any more for individual tracks.

Object of the present invention is to provide a tracking method and an optical disk drive utilizing a tracking method for both read-only and (re-)writable format disks that remains robust while the spatial frequency approaches or even exceeds 2 NA/λ.

The object according to a first aspect of the invention is achieved by an optical disk drive comprising a beam generator arranged to project a plurality of (n) satellite light spots (S₁, . . . , Sₙ;S_{L}, S_{M}) and one main spot (S_{R}) onto an optical disk, each satellite spot being displaced by a different path

$$( \frac{{TP}_{1}}{2} \neq \frac{{TP}_{1}}{2} \neq … \neq \frac{{TP}_{n}}{2} )$$

in radial direction off the main spot, whereby the double sum of radial displacement paths (TP_{Σ}=TP₁+ . . . +TPₙ) is higher than the reciprocal optical cutoff λ/(2 NA) of the beam, and a tracking error detection device comprising a photo detector array (71, 72) with at least two separate detector elements (71a, 71b, 72a, 72b) arranged to detect a reflected light from the optical disk corresponding to each of said satellite light spots (S₁, . . . , Sₙ;S_{L}, S_{M}), and at least one push-pull signal generator coupled to the detector array and arranged to generate differential push-pull signals (PP₁, . . . ,PPₙ; PP_{L}, PP_{M}), corresponding to each of said satellite light spots (S₁, . . . , Sₙ;S_{L}, S_{M}) on the basis of the output signals of the detector elements.

The invention is based on a new optical storage disk (for both read-only and (re-)writable applications) comprising a plurality of adjacent track portions with a radial track pattern in which a number n≧2 of adjacent track portions repeatedly exhibit non-uniform radial track distances TP₁≠TP₂ . . . ≠TPₙ. Unlike conventional disk formats, herein, tracks are not equidistantly spaced. Instead, several alternating track distances TP₁ to TPₙ are introduced. In other words, n adjacent track portions with non-uniform radial track distances form a bundle which periodically repeats at a spatial bundle period TP_{Σ}=TP₁+ . . . +TPₙ₋₁+TPₙ. Therein, TP₁ to TPₙ₋₁ are the radial distances between the track portions within the bundle and TPₙ is the radial distance between the last (n^{th}) track portion of a bundle to the adjacent first track portion of the next bundle. The bundle period may be still larger than λ/(2 NA) even when each of TP₁ to TPₙ falls below this lower limit.

This new period is made use of to achieve tracking in accordance with the invention. As a result, higher storage densities and better system robustness can be achieved although the radial track distances are narrowed below the optical cut-off limit.

According to a second aspect of the invention which constitutes a further development of the first aspect a signal combiner is coupled to each push-pull signal generator of the at least one push-pull signal generator and arranged to combine said push-pull signals (PP₁, . . . ,PPₙ; PP_{L}, PP_{M}) to a common tracking error signal (PP).

According to a further aspect of the invention the object is achieved by a tracking error detection method for an optical storage system comprising an optical disk drive and an optical disk, the optical disk comprising a plurality of adjacent track portions with a radial track pattern in which a number n≧2 of adjacent track portions repeatedly exhibit non-uniform radial track distances (TP₁≠TP₂ . . . ≠TPₙ), whereby the sum of said radial track distances (TP_{Σ}=TP₁+ . . . +TPₙ) is higher than the reciprocal optical cutoff λ/(2 NA) of the optical disk drive. The method comprises projecting a plurality of (n) satellite light spots (S₁, . . . , Sₙ; S_{L}, S_{M}) and one main spot (S_{R}) onto said optical disk, each satellite spot being displaced in radial direction off the main spot by another one of half the radial track distances

$$( \frac{{TP}_{1}}{2} \neq \frac{{TP}_{1}}{2} \neq … \neq \frac{{TP}_{n}}{2} ) ,$$

respectively, and generating push-pull signals (PP₁, . . . ,PPₙ; PP_{L}, PP_{M}) for each satellite spot.

Preferably the push-pull signals (PP₁, . . . ,PPₙ; PP_{L}, PP_{M}) are combined to a common tracking error signal (PP).

Further embodiments of the invention are described by the features in the appendant claims.

The above an other objects, features and advantages of the present invention will become apparent from the following description of a preferred embodiment thereof taken in conjunction with the accompanying drawing. In the drawing

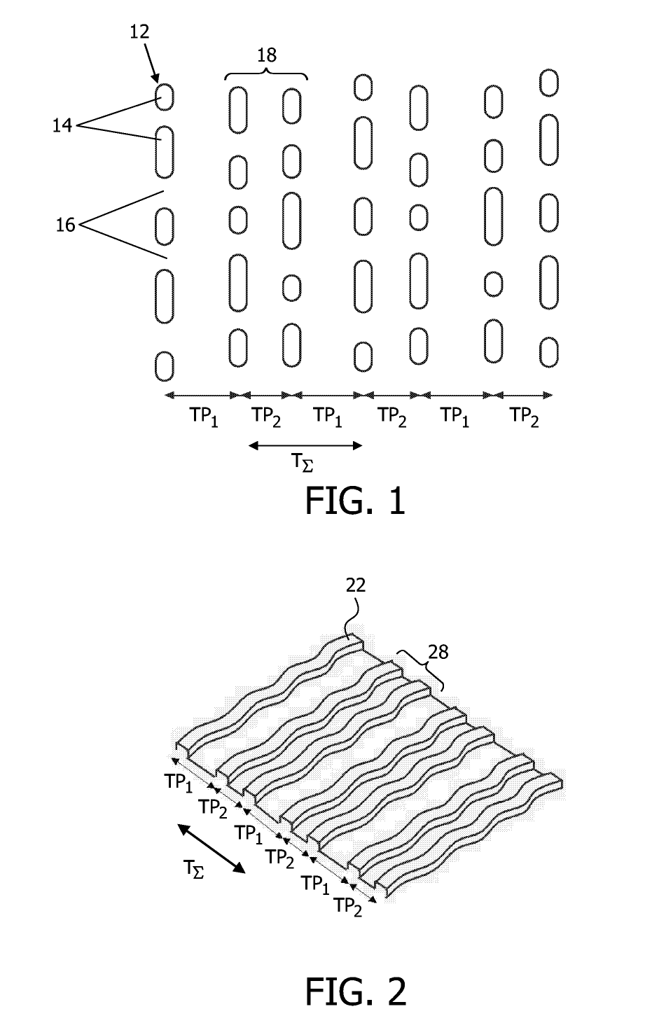

FIG. 1 shows a section of a read-only disk with non-uniform track pitches according to a first embodiment of the present invention;

FIG. 2 shows a perspective view of a section of a (re-)writable disk with non-uniform track pitches according to a second embodiment of the present invention;

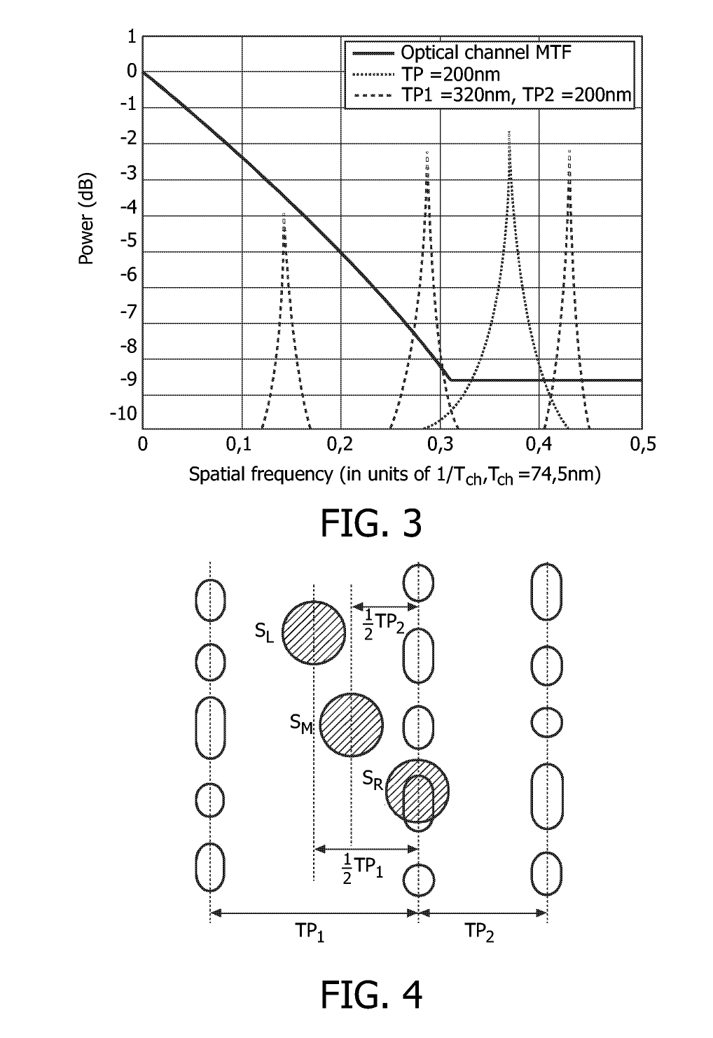

FIG. 3 is a graph showing radial spatial frequency analysis of an embodiment of the present invention for Blu-ray optics;

FIG. 4 illustrates schematically a disk structure and a three-spot set-up for reading, writing and tracking;

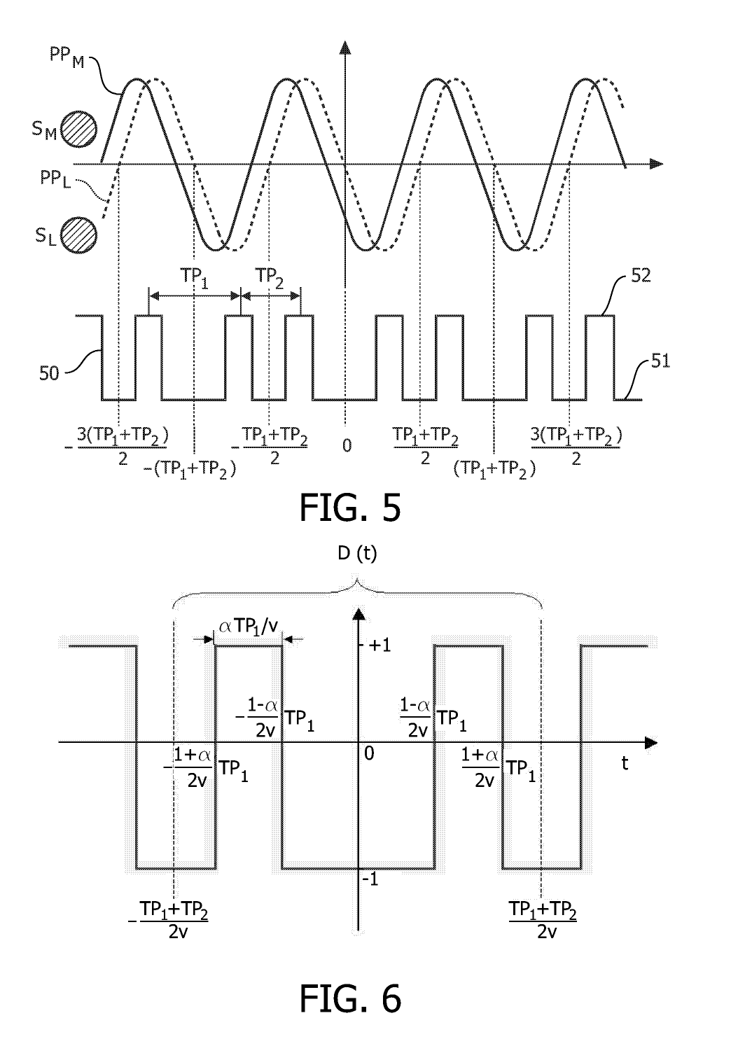

FIG. 5 is a diagram showing the push-pull signals from two tracking spots in FIG. 4;

FIG. 6 shows a graph of a track structure function D(t);

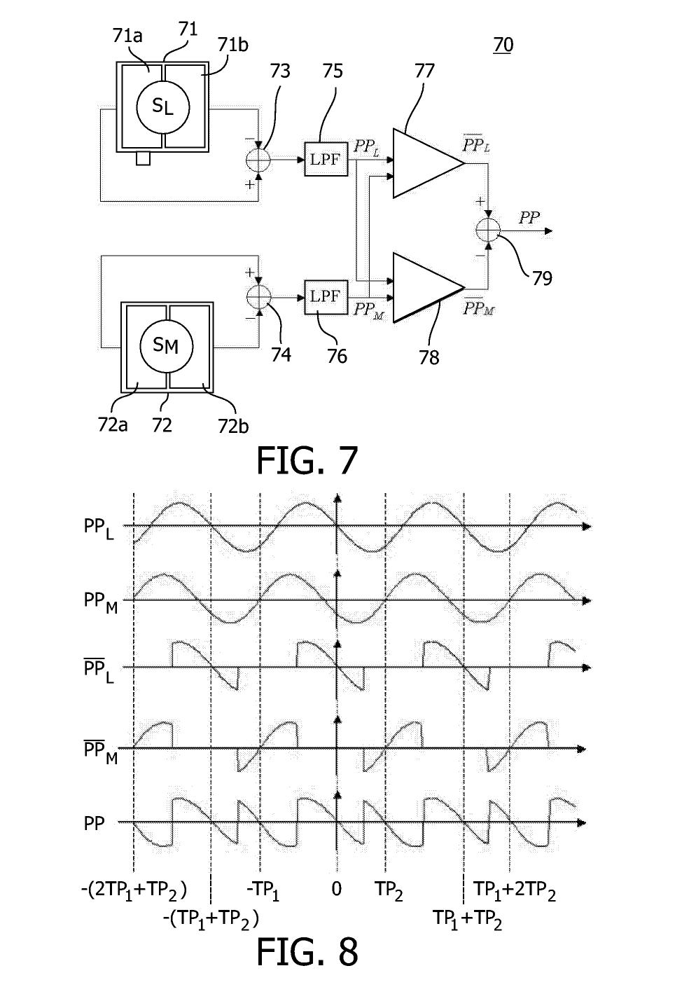

FIG. 7 shows a schematic diagram of a push-pull tracking error signal generator; and

FIG. 8 illustrates signal waveforms generated by the generator set-up of FIG. 7.

The section of the new disk shown in FIG. 1 represents a read-only format disk. The track portions 12 therein are formed by trajectories of pits 14 and lands 16. Similarly in FIG. 2, a perspective view of a section 20 of a (re-)writable disk is shown, wherein the track portions are formed by wobbled pre-grooves 22. Such pre-grooves for tracking purposes in an unwritten optical disk are well known, for example, from CD-R/RW, DVD±R/RW or BD-R/RE standards and the like.

Track portions 12, 22 in both formats, the tangential trajectories of pits and lands in the read-only format and pre-grooves in the (re-)writable format, are not equidistantly spaced. Two different track pitches TP₁ and TP₂ are chosen so that each second track portion is placed at a first distance TP₁ from its neighboring track portion to the left and at a second distance TP₂ from its adjacent track portion to the right. In this way a bundle 18 and 28, respectively, of two adjacent track portions is formed, which repeats at a spatial (bundle) period TP_{Σ}=TP₁+TP₂.

While for the conventional format, the uniform track pitch TP must satisfy TP>λ/(2 NA) because of the aforementioned reason, according to the new disk format, this problem is solved since instead of TP the spatial bundle period TP₁+TP₂ may be still larger than λ/(2 NA) even when each of TP₁ to TPₙ falls below this lower limit.

This spatial bundle period is made use of in the present invention to achieve tracking as will be explained more clearly by an example with reference to FIG. 3. Herein, the spectra of different radial spatial structures for Blu-ray optics are plotted. For comparison, the optical channel modulation transfer function (MTF) based on the Braat-Hopkins formula is also plotted (solid line) that has an optical cutoff around 0.3127 in the units of 1/T_{ch} (T_{ch}=74.5 nm). The dotted curve indicates the spatial frequency position with TP=200 nm. Obviously, it is already beyond the cutoff so that the conventional tracking becomes impossible. Choosing the track pitch structure of one of the FIGS. 1 or 2 with TP₁=320 nm and TP₂=200 nm, one can see that a frequency component of about 0.14 corresponding to TP_{Σ}=TP₁+TP₂=520 nm appears as a spike (dashed curve) below the cutoff within the optical pass-band.

One of the possible ways to make use of this spatial frequency component for tracking purposes is illustrated in FIG. 4. Three laser spots are employed, a main spot S_{R} on the right for reading and/or writing and two satellite spots S_{M} and S_{L} in the middle and on the left for tracking, respectively. When S_{R} is exactly aligned with the target track, S_{M} and S_{L} are located

$$\frac{1}{2} {TP}_{2} and \frac{1}{2} {TP}_{1}$$

off the target track, respectively. In other words, the satellite spots S_{M} and S_{L} are displaced by different paths,

$$\frac{1}{2} {TP}_{2} and \frac{1}{2} {TP}_{1} ,$$

respectively, in radial direction off the main spot S_{R}.

The three spots can be generated, for example, by a diffraction grating assembly for splitting a single laser beam into three beams and directing them in radially displaced directions on the disk, and a single or separate objective lenses for controlling the focus of the beams. As usual, the two tracking spots can have much lower light intensity than the read/write spot, and they should be placed additionally at a certain distance from each other in tangential direction with respect to the tracks to prevent interference, as illustrated in FIG. 4. While said disk is radially scanned, from the reflections of the spots S_{M} and S_{L} push-pull signals are derived utilizing a tracking error detection device as described in more detail with reference to FIG. 7.

In this way one will obtain two curves with the same shape, having a period of

T=TP₁+TP₂

and a phase difference of

$$Δφ = π \frac{{TP}_{1} - {TP}_{2}}{{TP}_{1} + {TP}_{2}} .$$

The push-pull signals will exist as long as the following conditions

$$T > \frac{λ}{2 NA} and {TP}_{1} \neq {TP}_{2} \qquad ( 1 )$$

are satisfied.

An example of these two push-pull signals is shown in the upper part of FIG. 5. In the lower part the corresponding traversed track structure 50 is given which exhibits land areas (or inter-track spacing) 51 between tracks and groove areas 52 actually forming tracks. Although, for better intelligibility, the land-groove structure of (re)writable disks is chosen in this example, it is to be noted that similar to the situation in FIG. 4, the invention also applies to read-only format disks having a pit-land structure without pre-grooves.

In the upper part of FIG. 5, the solid curve is the push-pull signal PP_{M} belonging to the spot S_{M} and the dashed curve is the push-pull signal PP_{L} belonging to the spot S_{L}. As can be seen from curve 50, at the middle of each land area 51 the track pattern is symmetric in radial direction although track pitches are not uniform. When either spot is located right above the middle of a land area the related push-pull signal, consequently, becomes zero. Note that the depicted traversing track structure 50 in the lower part of FIG. 5 is aligned with the push-pull signal PP_{L} of S_{L}.

Due to the radial displacement of

$$\frac{1}{2} {TP}_{2} and \frac{1}{2} {TP}_{1}$$

off the main spot S_{R}, the main spot S_{R} is on track every second time a zero-crossing appears in PP_{M} and every second time a zero-crossing appears in PP_{L}. In the example of FIG. 5, S_{R} is on track when PP_{L} crosses zero with negative slope; of course, the sign of the slope can be arbitrarily chosen by means of appropriate signal processing. Thus, the full tracking information is already contained in the aggregation of all push-pull signals PP_{M} and PP_{L}.

With a uniform track pitch the track pattern is symmetric in radial direction also at the middle of each groove area and, therefore, the push-pull signal becomes zero not only when the spot is located in the middle between tracks but also in the center of a track. According to invention, as pointed out above, due to the radial asymmetry of the tracks only the middle of the inter track spacing is distinguished. It is to be noted that, deviating from the illustration in FIG. 5, an extra zero crossing might appear somewhere between the center lines of adjacent land areas, at which reflected light intensities on the two halves of the detector get balanced. However, this push-pull zero point can be eliminated by properly tuning the ratio of TP₁ and TP₂ as well as the duty cycle. The general required condition is written as the following:

$$\begin{matrix}\frac{\partial h ( t )}{\partial t} * {\sum }_{n = - ∞}^{∞} D ( t - n \frac{{TP}_{1} + {TP}_{2}}{v} ) = 0 , only when \\ t = \pm N \frac{{TP}_{1} + {TP}_{2}}{2 v} , N = 0 , 1 , 2 , … .\end{matrix} \qquad ( 2 )$$

Therein h(t) represents the time domain impulse response of the optical channel, * the convolution and v the traversing velocity of the spot. D(t) is a function describing the track structure within one period, that is,

$$from - \frac{{TP}_{1} + {TP}_{2}}{2} to \frac{{TP}_{1} + {TP}_{2}}{2}$$

$$D ( t ) = \{ \begin{matrix}- 1 , & t ∈ [ - \frac{{TP}_{1} + {TP}_{2}}{2 v} , - \frac{1 + α}{2 v} {TP}_{1} ) , \\ & [ - \frac{1 - α}{2 v} {TP}_{1} , \frac{1 - α}{2 v} {TP}_{1} ] , \\ & ( \frac{1 + α}{2 v} {TP}_{1} , \frac{{TP}_{1} + {TP}_{2}}{2 v} ] , \\ + 1 , & t ∈ [ - \frac{1 + α}{2 v} {TP}_{1} , - \frac{1 - α}{2 v} {TP}_{1} ) , \\ & ( \frac{1 - α}{2 v} {TP}_{1} , \frac{1 + α}{2 v} {TP}_{1} ] .\end{matrix} \qquad ( 3 )$$

The function D(t) is illustrated in FIG. 6, where +1 corresponds to the track area and −1 the inter-track spacing. The track width is set α TP₁ with 0<α<1 uniformly over the whole disk. In order to meet the condition in (2), the difference between TP₁ and TP₂ can be adjusted, for example, TP₂=TP₁/2. In general, the track pitch combination TP₁ and TP₂ can be chosen depending on various requirements, such as the disk capacity, the quality of tracking signals and cross-erase and cross-talk constraints.

Although all tracking information is contained in the aggregation of the push-pull signals PP_{M} and PP_{L} a common radial tracking error signal might be preferred which should be zero when the main reading/writing spot S_{R} sits on top of the target track, and non-zero elsewhere. Because of the non-uniform track pitches, the distances between two adjacent zeros of such a signal, consequently, must alternately take the value of TP₁ and TP₂. However, any one of the two push-pull signals cannot be utilized as radial tracking error signal alone since both of them have a period of TP₁+TP₂, i.e., the distance between neighboring zeros is (TP₁+TP₂)/2. Furthermore, due to the signal symmetry only every second zero-crossing signalizes alignment of the main spot, as can be seen in FIG. 5. Therefore, the push-pull signals PP_{M} and PP_{L} have to be appropriately combined to a common tracking error signal.

Such a combination can be implemented, for example, in a tracking error detection device 70 as shown schematically in FIG. 7. Some of the accordingly processed signals are depicted in FIG. 8. Again, the setup with two tracking spots S_{M} and S_{L} in FIG. 4 is applied. The spots are reflected by the disk and projected onto two photo detectors 71, 72 of the tracking error detection device 70. Each detector 71, 72 comprises two separate detector elements 71a, 71b and 72a, 72b aligned in tangential direction with the track, in accordance with present standards, measuring the signal difference between two pupil halves of the spots on separate detector elements. Their outputs, corresponding to the amount of light reflected onto each of the elements, are processed in separate push-pull signal generators, each assigned to one of the detectors. Each push-pull signal generator comprises one mixer 73, 74 coupled to the assigned detector and one low pass filter 75, 76 to which the differential output of the assigned mixer is fed. After low pass filtering, proper differential push-pull signals PP_{L} (from the spot S_{L}) and PP_{M} (from the spot S_{M}) are obtained and fed into a signal combiner. The signal combiner comprises two amplitude comparators 77 and 78 being inversely coupled to each of the low pass filter outputs. The amplitude comparator 77 outputs a signal P̅P̅_{L} which corresponds to the value of PP_{L} if PP_{L} >PP_{M} and 0 otherwise, while the amplitude comparator 78 outputs a signal P̅P̅_{M} which is 0 when PP_{L}>PP_{M} and which corresponds to the value of PP_{M} otherwise. The signal combiner further comprises a mixer 79 which finally subtracts the resulting output signals P̅P̅_{L} and P̅P̅_{M} delivering the common radial tracking error signal PP= P̅P̅_{L}− P̅P̅_{M}.

In the waveforms of FIG. 8 that are based on the push-pull signals obtained from a track pitch structure as shown in FIG. 5 one can see that the distance between zero-crossings of the resulting tracking error signal PP are located at distances of TP₁ and TP₂ alternately, i.e. they correspond to the track pitches. Tracking error detection on non-uniformly spaced tracks is thus realized.

Taking Blu-ray optics as an example and assuming

$${TP}_{2} = \frac{{TP}_{1}}{2} ,$$

the new tracking error signal exists as long as TP₂>80 nm, compared to the lower limit of the track pitch TP*=238 nm in the current disk formats. As a result, higher storage densities and better system robustness can be achieved while push-pull type of tracking methods are still applicable.

It is to be noted that the device and the signals shown in FIGS. 7 and 8 represent only one of a number of the possible ways to process the push-pull signals of both tracking spots S_{M} and S_{L} in order to derive tracking information. In particular there are many other possibilities to combine push-pull signals PP_{L}, PP_{M}, or in general, any number of push-pull signals PP₁, . . . ,PPₙ.

Although in the embodiment a dual track bundle and, correspondingly, three beam spots are utilized the invention as well applies to a tracking error detection method and a disk drive employing more than two satellite spots. In general, n adjacent track portions can be arranged at non-uniform radial track distances (TP₁≠TP₂ . . . ≠TPₙ) accordingly being scanned by (S₁, . . . , Sₙ) satellite spots. The spots are displaced by a different path

$$( \frac{{TP}_{1}}{2} \neq \frac{{TP}_{1}}{2} \neq … \neq \frac{{TP}_{n}}{2} ) .$$

The new track format makes the cross-erase and cross-talk related issues independent of the tracking problem. One can do, for example in (re)writable disks, media evaluation to improve cross-erase effect without considering any constraints on tracking side. The tracking method is based on the combination of standard push-pull signals of two laser spots and enables robust tracking as well as addressing and timing recovery when track pitches approach or even exceed the conventional optical limit. As a result, higher storage densities can be achieved utilizing an established and only slightly modified tracking technology.

Another advantage is achieved in timing recovery and addressing. As well known, in many present (re)writable disk formats (like CD-R/RW, DVD±R/RW or BD-R/RE), a wobble is embedded in the grooves for carrying the timing and address information. Since it is formed by means of a track deviation from its central line, the wobble can be detected from the push-pull channel.

Yet another advantage is that embedding timing and address information onto a (re-)writable disks by way of a wobble structure still applies and, thus, the addressing on individual tracks remains. The only difference is that due to the tracking being done at inter-groove spacing the information is carried by wobbled lands instead of grooves, which can be solved in a modified mastering process.

1. Optical disk drive comprising a beam generator arranged to project a plurality of (n) satellite light spots (S₁, . . . , Sₙ;S_{L}, S_{M}) and one main spot (S_{R}) onto an optical disk, each satellite spot being displaced by a different path
$$( \frac{{TP}_{1}}{2} \neq \frac{{TP}_{1}}{2} \neq … \neq \frac{{TP}_{n}}{2} )$$
in radial direction off the main spot, whereby the double sum of radial displacement paths (TP_{Σ}=TP₁+ . . . +TPₙ) is higher than the reciprocal optical cutoff λ/(2 NA) of the beam, and
a tracking error detection device comprising a photo detector array (71, 72) with at least two separate detector elements (71a, 71b, 72a, 72b) arranged to detect a reflected light from the optical disk corresponding to each of said satellite light spots (S₁, . . . , Sₙ;S_{L}, S_{M}), and at least one push-pull signal generator coupled to the detector array and arranged to generate push-pull signals (PP₁, . . . ,PPₙ; PP_{L}, PP_{M}), corresponding to each of said satellite light spots (S₁, . . . , Sₙ;S_{L}, S_{M}) on the basis of the output signals of the detector elements.

2. Optical disk drive according to claim 1,
characterized by a signal combiner coupled to each push-pull signal generator of the at least one push-pull signal generator and arranged to combine said push-pull signals (PP₁, . . . ,PPₙ; PP_{L}, PP_{M}) to a common tracking error signal (PP).

3. Optical disk drive according to claim 1,
characterized in that the beam generator is arranged to project two satellite light spots (S_{L}, S_{M}) and one main spot (S_{R}) onto the optical disk, and in that the tracking error detection device comprises a separate photo detector (71, 72) having at least two detector elements (71a, 71b, 72a, 72b) being aligned in tangential direction with respect to tracks on the disk and a push-pull signal generator coupled to the photo detector (71, 72) for each of the two satellite spots (S_{L}, S_{M}).

4. Optical disk drive according to claim 3,
characterized in that the signal combiner comprises a first amplitude comparator (77) and a second amplitude comparator (78) inversely coupled to each push-pull signal generator, whereby the first amplitude comparator (77) is arranged to output a signal P̅P̅_{L} which corresponds to the value of PP_{L} if PP_{L}>PP_{M} and 0 otherwise, while the second amplitude comparator (78) outputs a signal P̅P̅_{M} which is 0 when PP_{L}>PP_{M} and which corresponds to the value of PP_{M} otherwise.

5. Optical disk drive according to claim 4,
characterized in that the signal combiner comprises merging means (79) arranged to merge said signals P̅P̅_{L} and P̅P̅_{M} output by the first and second amplitude comparators (77, 78) and to output a common tracking error signal PP.

6. Tracking error detection method for an optical storage system comprising an optical disk drive and an optical disk, the optical disk comprising a plurality of adjacent track portions with a radial track pattern in which a number n≧2 of adjacent track portions repeatedly exhibit non-uniform radial track distances (TP₁≠TP₂ . . . ≠TPₙ), whereby the sum of said radial track distances (TP_{Σ}=TP₁+ . . . +TPₙ) is higher than the reciprocal optical cutoff λ/(2 NA) of the optical disk drive, the method comprising:
projecting a plurality of (n) satellite light spots (S₁, . . . , Sₙ; S_{L}, S_{M}) and one main spot (S_{R}) onto said optical disk, each satellite spot being displaced in radial direction off the main spot by another one of half the radial track distances
$$( \frac{{TP}_{1}}{2} \neq \frac{{TP}_{1}}{2} \neq … \neq \frac{{TP}_{n}}{2} ) ,$$
respectively, and
generating push-pull signals (PP₁, . . . ,PPₙ; PP_{L}, PP_{M}) for each satellite spot.

7. Tracking error detection method according to claim 7,
characterized by combining said push-pull signals (PP₁, . . . ,PPₙ; PP_{L}, PP_{M}) to a common tracking error signal (PP).
